(19) United States
(12) Patent Application Publication
(10) Pub. No.: US 2003/0163401 A1
(43) Pub. Date: Aug. 28, 2003

(54) Forming agricultural transactions to share risk and reward

(76) Inventors: David E. Dines, Wayzata, MN (US); Jeffrey C. Seeley, Chanhassen, MN (US)

Correspondence Address: Peter Reyes, Cargill, Inc., Law Deptartment MS24, P.O. Box 5624, Minneapolis, MN, 55440-5624, US

(21) Appl. No.: 10/369,803

(22) Filed: Feb. 19, 2003

Related U.S. Application Data
(60) Provisional application No. 60/359,322, filed on Feb. 22, 2002.

(51) Int. Cl. G06F 17/60

(52) U.S. Cl. 705/35

(57) ABSTRACT

The invention is directed to techniques in which a producer of an agricultural commodity and a lender agree to share future risks, benefits, or both in a loan transaction. In addition to agreeing to a repayment of principal, the agricultural producer agrees to additional consideration, such as payment of a higher interest rate or a fee, or a promise to share the benefit of a high market price. In exchange for the consideration, the lender agrees to provide some protection from a low market price, or to adjust the terms of the loan to favor the agricultural producer.

This application claims priority from U.S. application serial No. 60/359,322, filed Feb. 22, 2002, the entire content of which is incorporated herein by reference.

### TECHNICAL FIELD

The invention relates to the agriculture business and, more particularly, to financing production of agricultural commodities.

### BACKGROUND

Agricultural producers face substantial risks in producing an agricultural product, bringing it to market, and earning a profit. Individual farmers, for example, are especially susceptible to risk factors that can adversely affect yield, marketability and market price. Risk factors include weather conditions such as drought, hail, wind, frost, excess rain, plant disease, insects, market volatility, increased global capacity, and government regulations. In addition, agricultural producers may face a risk because of their own success. If agricultural producers as a group are too efficient and produce yields well above normal, they will flood the market with the agricultural product and drive the price of the product downward.

Before the growing season, many agricultural producers borrow money from a lending institution to pay expenses associated with producing the commodity. When the commodity is corn, for example, an agricultural producer may borrow money from a lending institution to pay expenses associated with planting and growing the corn. The agricultural producer expects to repay the loan principal, plus interest, with the proceeds from the sale of the commodity. Taking a loan creates new risks for the agricultural producer. In a year when yields are above normal, for example, the market price for the commodity at the end of the growing season may be depressed, making repayment of the principal difficult.

To offset some of the risks, many agricultural producers enter into marketing agreements with buyers of agricultural products. The agreements often set prices based upon futures, in which the agricultural producer agrees to sell a quantity of a product at a future time in exchange for a fixed price. Promising to sell a specified quantity of a commodity at a future time at a specified price is sometimes called “forward selling.”

Many agriculture producers also purchase crop insurance to offset some of the risk. Two widely available forms of crop insurance are yield insurance and revenue insurance, both available through administrative agencies of the United States Government. The latter form of insurance generally provides more comprehensive coverage, but is also more expensive. When purchasing either form of insurance, an agricultural producer typically self-insures to some extent. For example, an agricultural producer may insure eighty percent of his actual production history (APH), thereby bearing twenty percent of the risk of not producing a yield equal to his APH. The APH is a measure of the actual yields of the agricultural producer, usually in bushels per acre, over a specified time period, usually five years.

To offset other risks, the United States Government provides minimum price supports. In general, the Government establishes a price level, in units such as cents per bushel, which serves as a floor price. If the market price drops below the government-established floor price, the Government may compensate agricultural producers by making up the difference between the government-established floor price and the market price. This payment from the Government is a subsidy, not a purchase of the agricultural products.

### SUMMARY

In general, the invention is directed to techniques for financing production of agricultural commodities and managing the risks of marketing of agricultural commodities. More particularly, the invention is directed to techniques for sharing risk between an agricultural producer and a lender, i.e., a party that loans an amount of principal to the agricultural producer to produce the commodity. The lender may be, for example, a bank. In some circumstances, the lender may be a buyer of the commodity.

In exchange for the principal of the loan, the agricultural producer provides some consideration. In a conventional loan, the consideration may be a promise to repay the principal plus interest at a prevailing interest rate. Consistent with the techniques of the invention, the agricultural producer agrees to repay the principal plus interest, if any, and may provide other consideration. In exchange for the consideration, the lender agrees to adjust the terms of the loan.

For example, the agricultural producer may provide consideration in the form of a promise to pay an extra sum in exchange for future sharing of risk by the lender. The extra sum may include an agreement to pay an increased interest rate or a fee. In the event an end-of-season market price for a commodity is low, the lender may promise to adjust the terms of the agreement in favor of the agricultural producer. The lender may reduce the principal, the interest, or both.

In another example, the consideration from the agricultural producer may take the form of a promise to share a potential future benefit in exchange for a present reduction in lending costs. In the event the end-of-season market price for the commodity is high, the agricultural producer may share with the lender the benefits of the high market price. In exchange for this consideration, the lender may provide the principal at a reduced rate of interest, or at no interest.

The agreement between the parties may combine these techniques. The agricultural producer and the lender may agree to share the risks in the event the end-of-season market price is low, and share the benefit in the event the end-of-season market price is high. The consideration provided by the agricultural producer may be a function of the degree of sharing.

The parties may define price levels or other criteria for determining when the end-of-season market price is “low” or “high.” One technique, for example, is to select price levels, referred to herein as a critical high price and a critical low price. When the end-of-season market price is above the agreed upon critical high price, the parties share the benefits. When the end-of-season market price is below the agreed upon critical low price, the parties share the risks. The parties may define the critical high price and the critical low price with respect to a reference price such as a futures price.

Furthermore, the use of the end-of-season market price is merely an exemplary benchmark. The parties may define “low” and “high” in terms of other benchmarks, such as the average price of the commodity for the season.

A commodity buyer has all of the alternatives of the lender described above, such as adjusting principal, forgiving interest and sharing in proceeds. In addition, because the buyer is also a purchaser of the commodity produced by the agricultural producer, the buyer may have a wider range of options than the lender for sharing of risks of a low end-of-season market price and sharing benefits when the end-of-season market price is high.

For example, the agricultural producer and the buyer may agree to ceiling and floor prices. More specifically, the buyer may agree to pay the agricultural producer the floor price if the end-of-season market price is below the floor price. Similarly, the agricultural producer may agree to sell to the buyer at the ceiling price if the end-of-season market price is above the ceiling price. Other forms of risk sharing and benefit sharing are possible.

The buyer may finance the loan made to the agricultural producer through the lender, borrowing principal at an interest rate, and agreeing to repay the principal and the interest. If the buyer is a large entity, the buyer may be able to obtain a lower interest rate from the lender than the agricultural producer could obtain. In addition, the buyer may have resources to distribute the risks associated with high interest rates or a low end-of-season market price, such as by the purchase or sale of derivatives on the commodities markets.

In another embodiment, the agricultural producer may obtain financing from a lender, and the lender may distribute the risks of the financing by forming an agreement with a guarantor. The guarantor may agree to bear some of the risks in exchange for a share of potential benefits in the event end-of-season prices are high.

The details of one or more embodiments of the present invention are set forth in the accompanying drawings and the description below. Other features, objects, and advantages of the present invention will be apparent from the description and drawings, and from the claims.

### DESCRIPTION OF DRAWINGS

FIG. 1 is a diagram illustrating an exemplary transaction between an agricultural producer and a lender consistent with the principles of the invention.

FIG. 2 is a diagram illustrating another exemplary transaction between an agricultural producer and a lender consistent with the principles of the invention.

FIG. 3 is a diagram illustrating another exemplary transaction between an agricultural producer and a lender in a manner that makes use of elements of the embodiments shown in FIGS. 1 and 2.

FIG. 4 is a flow diagram further illustrating details of an embodiment of the invention.

FIG. 5 is a diagram illustrating an exemplary transaction involving an agricultural producer, a buyer and a lender according to the principles of the invention.

FIG. 6 is a diagram illustrating an exemplary transaction involving an agricultural producer, a lender and a guarantor according to the principles of the invention.

### DETAILED DESCRIPTION

When an agricultural producer borrows money to produce a commodity, the agricultural producer and the lender assume some risk. The agricultural producer is at risk of being unable to repay the loan. Risk of default may be higher in productive growing seasons, when a surplus of commodity drives the market price down. An agricultural producer may find it difficult to repay the principal and interest from the proceeds of the sale of the commodity when the market price is low. In such circumstances, the lender is at risk as well. The lender is at risk of losing the principal and interest, or of not being paid in a timely fashion.

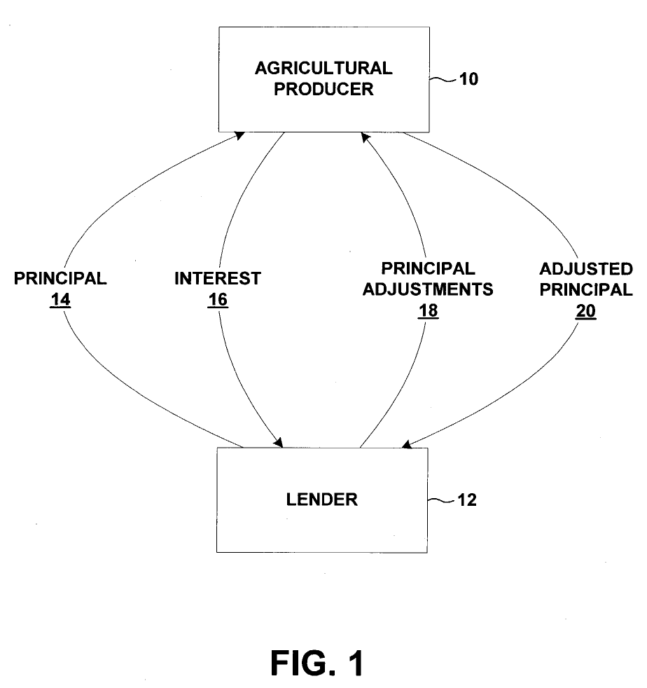

In general, the invention is directed to techniques for sharing of risks between lender and an agricultural producer. The invention involves adjustments to the traditional practice of lending. FIG. 1 is a diagram illustrating an exemplary transaction consistent with the principles of the invention. An agricultural producer 10 and a lender 12 enter into an agreement, in which agricultural producer 10 borrows a sum of principal 14 from lender 12. As consideration for the loan, agricultural producer 10 agrees to pay interest 16 on the principal 14 at loan maturity. Typically, agricultural producer 10 repays principal and interest following the sale of the agricultural commodity.

The prevailing interest rate on a conventional agricultural loan may be, for example, the prime rate plus one percent. In this application of the invention, however, agricultural producer 10 may agree to pay a higher interest rate 16, such as prime rate plus three percent. In exchange for the higher rate of interest, agricultural producer 10 receives consideration from lender 12 in the form of some protection in the event the end-of-season market price, or other benchmark price, is low. In particular, agricultural producer 10 receives a promise from lender 12 that, under certain described conditions, the financial hardship associated with repaying the loan will be reduced.

To reduce the financial hardship, lender 12 may, for example, agree to forgive part of the loan in the event the end-of-season market price is low. Lender 12 may elect to not collect principal 14, interest 16 or both. As illustrated in FIG. 1, lender 12 may agree to adjustments 18 to the principal 14 under certain circumstances. When those circumstances occur, agricultural producer 10 repays lender 12 at loan maturity the adjusted principal 20 plus interest 16, rather than the full principal 14 plus interest 16.

Producer 10 and lender 12 may agree upon a variety of circumstances that lead to principal adjustments 18. For example, the parties may define a “critical low price” for the commodity at which principal adjustments 18 are triggered. In this event, no principal adjustments 18 will be made if the market price remains above the critical low price, but some principal adjustment 18 will be made if the market price falls below the critical low price. In an embodiment that will be described below, the amount of principal adjustments 18 is dependent upon how far the market price falls below the critical low price. The critical low price may be established with reference to a futures price. For example, the parties may agree that the critical low price will be a certain number of cents below a particular futures price. Lender 12 may, however, be reluctant to agree to complete forgiveness of principal. Accordingly, lender 12 may insist that there be a limit to the adjustment to principal 18.

Although the critical low price may be defined with respect to the end-of-season market price, the critical low price may also be defined with respect to another benchmark price. For example, the parties may agree to use as a benchmark the average price for the season. In this variation, the parties may agree that the financial hardship associated with repaying the loan will be reduced when the critical low price falls below the average price. For simplicity, the end-of-season price will be used as the benchmark price in the following discussion.

For purposes of illustration, consider an agricultural producer 10 as an individual farmer who raises corn. At the outset of the growing season, the farmer and lender 12, such as a bank, agree to a loan so that the farmer can purchase corn seed for the coming growing season. The farmer may also use the principal of the loan to purchase other inputs, such as fertilizer and pesticide. The bank takes a security interest in the new crop corn that is to be grown. In addition, the bank charges interest to the farmer for the loan. In a standard loan, the prevailing interest rate may be, for example, prime plus one percent.

When the farmer and the bank enter into the loan agreement, suppose the futures price on corn is $2.30 per bushel. The farmer is concerned that the market price at the end of the growing season may be low. In particular, the farmer is concerned about loss of profitability and the risk of being unable to repay principal with interest to the bank. Accordingly, the farmer and the bank make an agreement whereby, in exchange for paying a higher interest rate, the farmer will receive some protection in the event the end-of-season market price is low.

Assume the farmer agrees to pay prime plus three percent, and that the parties agree that the critical low price shall be fifty cents below the futures price, or $1.80. The parties further agree that for every penny per bushel the market price is below the critical low price, the principal will be forgiven by a predefined percentage.

Further assume that the parties agree to limit the principal adjustments. If the market price falls below $1.36, no further principal adjustments will be made. Moreover, the farmer will be liable for at least fifty percent of the principal. If the parties agree that principal adjustments 18 are made in equal amounts, the principal 14 would be reduced by approximately 1.13636 percent for every penny per bushel the market price falls below $1.80. If the market price falls to $1.36 per bushel, then principal will have been reduced by fifty percent, and will be reduced no further.

Assume that the end-of-season market price is $1.85 per bushel. This price is above the critical low price. At loan maturity, the farmer owes the bank the entire amount of the principal 14, plus any unpaid interest 16, at the agreed upon high rate.

If the end-of-season market price is $1.69 per bushel, however, the market price is eleven cents below the critical low price. Accordingly, principal 14 is reduced by:

(11 cents below critical)(1.13636 percent percent below critical)=12.5 percent.

Consequently, the bank makes principal adjustments 18 to forgive 12.5 percent of principal 14. The farmer is still liable for 87.5 percent of the principal 14, plus unpaid interest 16 at the agreed upon rate. Although the year could have been a better one for the farmer, the burden of repaying the loan has been reduced.

In a third variation, assume that the end-of-season market price is $1.30 per bushel. Under these conditions, the bank makes principal adjustments 18 to forgive fifty percent of principal 12. The farmer is still liable for fifty percent of the principal 12, plus unpaid interest 14 at the agreed upon rate. Market prices below $1.36 per bushel resulted in no further principal adjustments.

Many variations consistent with the principles of the invention exist for this transaction. For example, lender 12 may charge a flat fee to agricultural producer 10, rather than increased interest. In another variation, lender 12 may combine low-price protection with high-price revenue sharing, as described below.

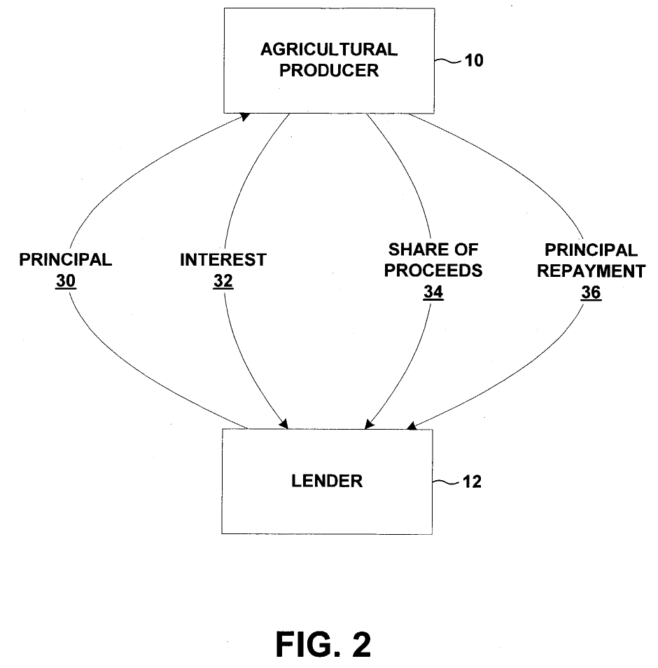

FIG. 2 is a diagram illustrating another exemplary transaction consistent with the principles of the invention. As before, agricultural producer 10 and lender 12 enter into an agreement, in which agricultural producer 10 borrows a sum of principal 30. In consideration for the loan, agricultural producer 10 further agrees to pay interest 32 on the principal 30 at loan maturity. In this application, however, the interest rate may be lower than the conventional interest rate. In an extreme example, the rate of interest 32 may be lowered to zero, in which case the loan is a no-interest loan. In exchange for the reduced rate of interest, agricultural producer 10 agrees to share some of the rewards 34, e.g., the proceeds of the from the sale of the commodity, with lender 12 in the event the end-of-season market price, or another agreed upon benchmark price, is high. Agricultural producer 10 also agrees to repay the principal of the loan 36.

Agricultural producer 10 and lender 12 may agree upon a variety of price levels and criteria for sharing proceeds 34. For example, the parties may define a “critical high price” at which sharing is triggered. Under this type of agreement, no sharing will occur if the market price is below or equal to the critical high price, but some sharing will occur if the price is above the critical high price. As with the critical low price, the critical high price may be established with reference to a futures price.

The sharing may be according to a flat rate or a sliding scale. Agricultural producer 10 may agree, for example, to pay lender 12 a percentage of every penny per bushel earned above the critical high price. In this way, both agricultural producer 10 and lender 12 benefit from a high market price.

For purposes of illustration, consider again the example above in which the individual farmer raises corn in view of FIG. 2. At the outset of the growing season, the farmer and a bank agree to a loan so that the farmer can purchase corn seed and other inputs for the coming growing season. As before, the futures price on corn is $2.30 per bushel. Suppose the farmer feels the prevailing interest rate is too high. Accordingly, the farmer and the bank make an agreement whereby, in exchange for receiving a lower interest rate, the farmer will agree to share proceeds 34 with the bank in the event the end-of-season market price is high.

Assume that the bank agrees to lend at prime minus three percent, and that the critical high price shall be twenty-five cents per bushel above the futures price, or $2.55. For every penny per bushel the market price is above the critical high price, the farmer will pay the bank three quarters of one cent per bushel. The farmer does not share with the bank the benefit of the first twenty-five cents per bushel above the futures price.

Assume that the end-of-season market price is $2.50 per bushel. This price is below the critical high price. At loan maturity, the farmer owes the bank the principal 30, plus any unpaid interest 32, and the farmer has received the benefit of an interest rate below the prevailing rate. The farmer repays the principal 36 plus interest 32, but need not share any of the proceeds of the sale with the bank.

If the end-of-season market price is $2.67 per bushel, however, the market price is twelve cents above the critical high price. In addition to receiving a repayment of the principal 36 plus interest 32, the bank shares in some of the proceeds 34 of the sale of the corn. For each bushel sold at $2.67, the farmer receives $2.55 plus twenty-five percent of twelve cents, for a total of $2.58 per bushel. The bank receives nine cents per bushel, or seventy-five percent of twelve cents. In this prosperous season, the farmer and the bank share the benefit of a high market price. The farmer has traded some of this uncertain future benefit for a certain present benefit, i.e., an interest rate below the prevailing interest rate.

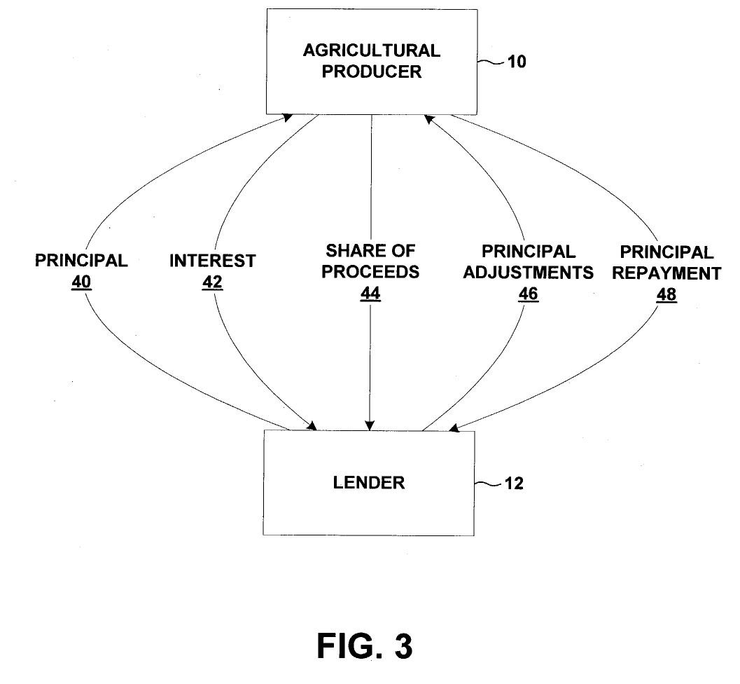

FIG. 3 shows a further exemplary transaction consistent with the principles of the invention that makes use of many of the concepts of the applications illustrated in FIGS. 1 and 2. Agricultural producer 10 and lender 12 enter into an agreement, in which agricultural producer 10 borrows a sum of principal 40. Agricultural producer 10 further agrees to pay interest 42 on principal 40 at loan maturity. The interest rate may be function of the risk sharing between agricultural producer 10 and lender 12.

Agricultural producer 10 may be concerned about financial hardship in the event of a low end-of season market price, and may want low-price protection. Agricultural producer 10 may also be willing to share the uncertain future benefit of a high market price in exchange for a certain present benefit such as an interest rate below the prevailing rate.

Accordingly, the parties may define a critical low price and a critical high price. If the end-of-season market price is above the critical high price, lender 12 shares in the proceeds of the sale 44. If the end-of-season market price is below the critical low price, lender 12 adjusts the amount of principal owed by agricultural producer 10. Agricultural producer 10 further agrees to repay the principal 48, taking into account principal adjustments 46, if any.

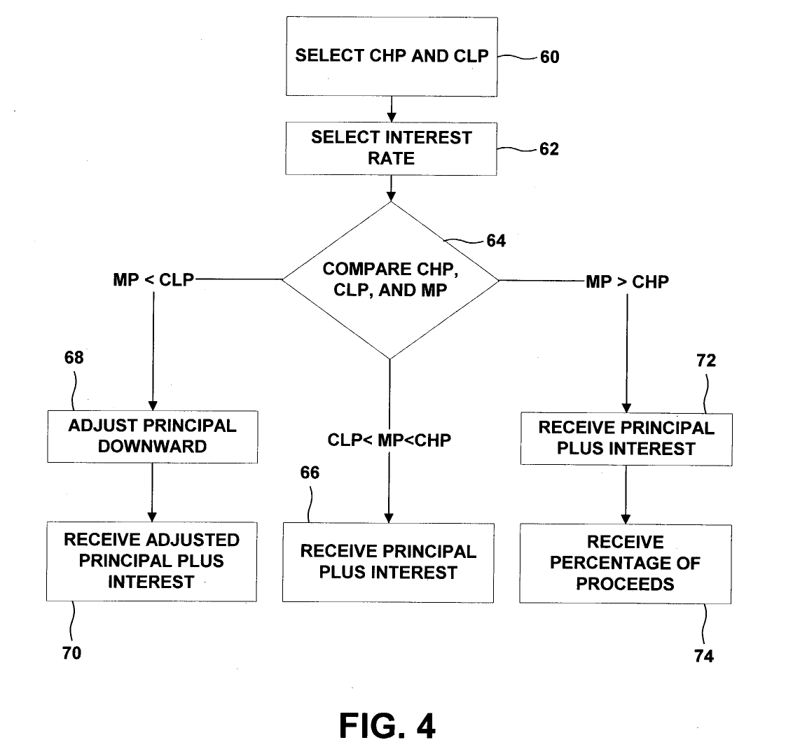

FIG. 4 is a flow diagram further illustrating the transaction described by FIG. 3. At the outset of the season, agricultural producer 10 and lender 12 agree to a critical high price and a critical low price (60). Agricultural producer 10 and lender 12 may select the critical high price and critical low price with respect to a reference price, such as a current market price for a commodity futures contract. The critical high price and the critical low price may be different intervals from the reference price. In the examples given above, the critical high price was twenty-five cents above the reference price, and the critical low price was fifty cents below the reference price.

Agricultural producer 10 and lender 12 may further agree to an interest rate (62), based upon factors such as the prime rate, and the probabilities that the end-of-season market price will be lower than the critical low price or higher than the critical high price. The interest rate may be below the prevailing interest rate.

At the end of the season, the components of the transaction are controlled by a comparison of a benchmark price, such as the market price (MP), and the agreed upon terns, such as the critical high price (CHP) and the critical low price (CLP) (64). If the market price (MP) is between the critical high price (CHP) and critical low price (CLP), then the lender receives the agreed upon principal and interest (66). The lender does not adjust the principal to favor the agricultural producer, neither does the lender share in the proceeds of the sale of the crop.

In the case when the market price (MP) is below the critical low price (CLP), the lender adjusts the principal downward (68). The lender receives the principal, as adjusted, plus interest (70). In the case when the market price (MP) is above the critical high price (CHP), the lender receives the principal plus interest (72), and further shares in the proceeds of the sale (74).

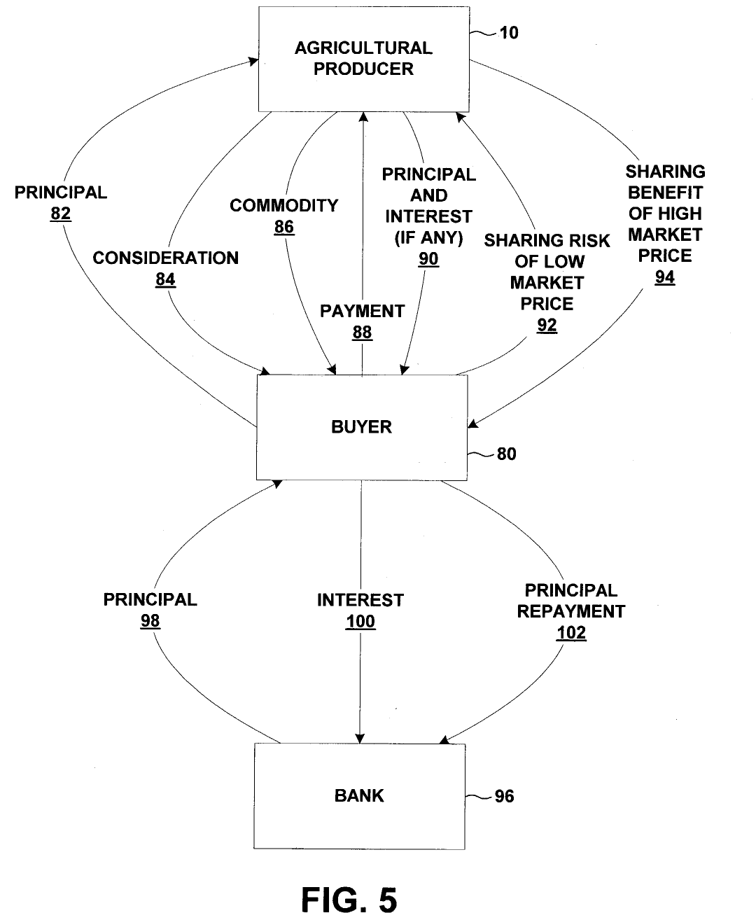

FIG. 5 is a diagram illustrating an exemplary transaction involving an agricultural producer, a buyer and a lender according to the principles of the invention. In this embodiment, arrangements similar to those described above may be made by a party such as a buyer of the crop. Instead of borrowing directly from a lender such as a bank, agricultural producer 10 borrows from buyer 80. In exchange for principal 82, agricultural producer 10 provides some consideration 84. Consideration 84 may be, for example, a promise to share the benefits of a high market price with buyer 80, or a promise to pay interest at a rate different from the prevailing interest rate, or a fee.

Agricultural producer 10 agrees to sell the commodity 86 to buyer 80 at a future date, and buyer 80 agrees to pay for the commodity 88. Agricultural producer 10 further agrees to repay principal with interest 90, if any. In some circumstances, principal 82 may be loaned at no interest. Agricultural producer 10 and buyer 80 may further agree to a sharing of risk 92 when the end-of-season market price is low, and a sharing of benefits 94 when the end-of-season market price is high. Agricultural producer 10 and buyer 80 may select a critical high price and a critical low price, using techniques such as those described above, that define the terms under which the sharing of risks or benefits takes place.

Buyer 80 may have all of the alternatives of lender 12 described above, such as adjusting principal, forgiving interest and sharing in proceeds. In addition, because buyer 80 is also a purchaser of the commodity produced by agricultural producer 10, buyer 80 may have a wider range of options than lender 12 for sharing of risks 92 of a low end-of-season market price, and for sharing benefits 94 when the end-of-season market price is high.

For example, agricultural producer 10 and buyer 12 may agree to ceiling and floor prices. When the end-of-season market price is below the floor price, buyer 12 agrees to pay to agricultural producer 10 the floor price. When the end-of-season market price is above the ceiling price, agricultural producer 10 agrees to sell to buyer 80 at the ceiling price. Other forms of risk sharing and benefit sharing are possible.

Buyer 80 may finance the loan made to agricultural producer 10 through another entity, such as a bank 96, by borrowing principal 98 at an interest rate, and agreeing to repay principal 102 and interest 100. If buyer 80 is a large entity, buyer 80 may be able to obtain a lower rate for interest 100 from bank 96 than agricultural producer 10 could obtain. In addition, buyer 80 may have resources to distribute the risks associated with high interest rates or a low end-of-season market price, such as by the purchase or sale of derivatives on the commodities markets.

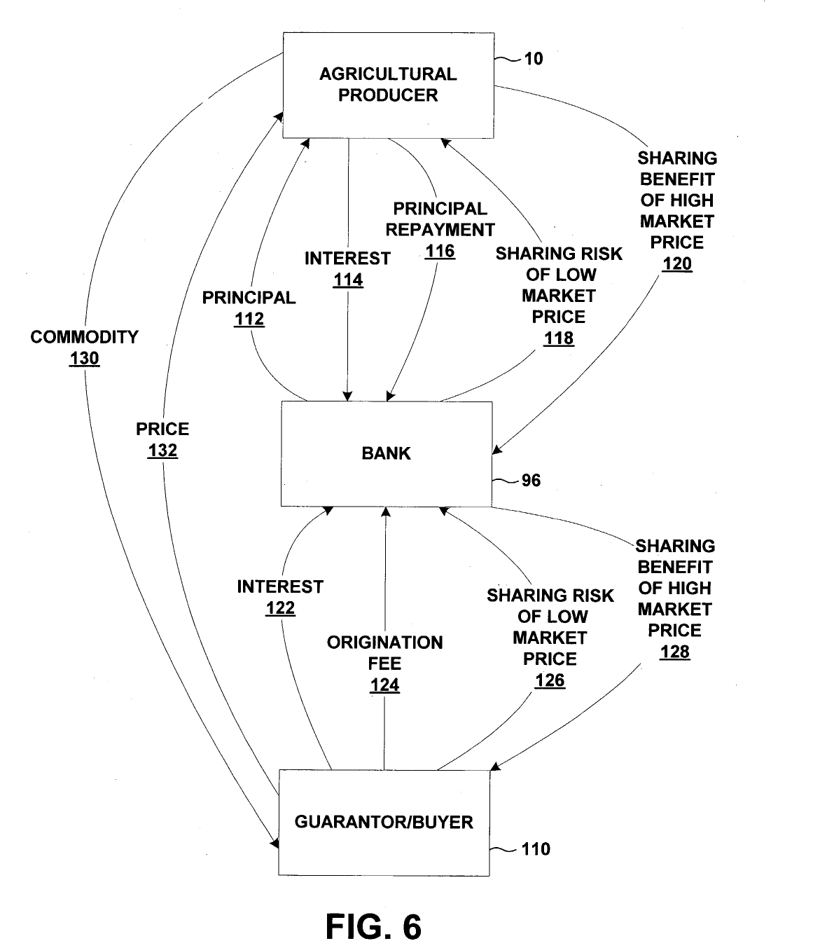

FIG. 6 is a diagram illustrating an exemplary transaction involving an agricultural producer, a lender and a guarantor according to the principles of the invention. In this embodiment, the guarantor 110 may also be a buyer of the commodity produced by the agricultural producer. The arrangements may be similar to those described above.

Agricultural producer 10 borrows from a lender such as bank 96. In exchange for principal 112, agricultural producer 10 agrees to pay interest 114 on the principal 112 at loan maturity. The interest rate may be lower than the prevailing interest rate. Agricultural producer 10 further agrees to repay principal 116.

Agricultural producer 10 and bank 96 may further agree to a sharing of risk 118 when the end-of-season market price is low, and a sharing of benefits 120 when the end-of-season market price is high. Agricultural producer 10 and bank 96 may select a critical high price and a critical low price, using techniques such as those described above, that define the terms under which the sharing of risks or benefits takes place.

Bank 96 may distribute the risks by forming an agreement with guarantor 110. Guarantor 110 may agree to pay bank 96 interest 122 on the principal 112 loaned to agricultural producer 10. Thus, bank 96 may collect interest from agricultural producer 10 and from guarantor 110 on the same principal. As further incentive to bank 96, guarantor 110 may agree to additional consideration, such as an origination fee 124 as a function of principal 112, or payment of interest 122 up front rather than at maturity, or both.

Guarantor 110 may further agree to compensate bank 96 in whole or in part 126 for losses associated with risk sharing 118 when the end-of-season market price is low. If bank 96 has agreed with agricultural producer 10 to an adjustment to principal, for example, guarantor 110 may agree with bank 96 to repay all or part of the principal adjustment. In exchange, bank 96 may agree to share 128 with guarantor 110 all or part of the benefits 120 when the end-of-season market price is high.

When guarantor 110 is also the buyer of the commodity, guarantor 110 may enter a sale agreement with agricultural producer 10. In exchange for the produced commodity 130, guarantor 110 pays agricultural producer 10 a price 132. The sale agreement may be independent of the other agreements shown in FIG. 6.

The invention may provide many advantages. An agricultural producer may have enhanced choice in managing risk. If the agricultural producer is concerned about a drop in the market price in the future that may affect his ability to repay a loan, the agricultural producer can trade a higher interest rate or other consideration for some protection against a low market price in the future. If the agricultural producer is concerned about interest rates, the agricultural producer can obtain a certain lower interest rate by sharing a potential future benefit, such as part of the proceeds of a sale at a high market price in the future. Lenders, buyers and/or guarantors also have enhanced choices for risk management, and need not rely exclusively on conventional financing techniques.

A number of embodiments of the present invention have been described. Nevertheless, various modifications may be made without departing from the scope of the invention. For example, the techniques described herein are not limited to corn. Nor are the techniques limited to crops, but can be applied to other commodities as well. An agricultural producer may borrow principal for raising of livestock, for example, and the agricultural producer and lender may enter into agreements similar to those described above. Furthermore, the forms of consideration are merely exemplary, and the invention is not limited to the particular forms of consideration explicitly mentioned herein.

The transactions described herein may be implemented by a contract between the parties, but the invention is not limited to circumstances in which the terms are memorialized in a single contract. The invention encompasses, for example, a loan agreement and a separate agreement pertaining to the sharing of risk, reward, or both.

As noted above, the critical low price or critical high price, or both, may be defined with respect to the end-of-season market price. The parties may agree to another benchmark price, such as an average price for the season. The average price is usually less volatile than the market price, and less likely to rise or fall as much as the market price. In general, the critical low price may be higher when the benchmark price is the average price rather than the end-of-season price. Similarly, the critical high price may be lower when the benchmark price is the average price rather than the end-of-season price. Other benchmark prices may be selected as well, and the critical high price and critical low price may depend upon which benchmark price the parties agree to use. The parties may agree to compare the critical low price to one benchmark, such as the average price, and to compare the critical high price to a second benchmark, such as the end-of-season price. These and other embodiments are within the scope of the following claims.

1. A method comprising forming an agreement to loan a principal amount from a lender to a borrower in exchange for a promise to share with the lender proceeds from a future sale of a commodity when a price for the commodity exceeds an agreed upon price level.

2. The method of claim 1, wherein the borrower comprises an agricultural producer.

3. The method of claim 1, wherein the lender comprises a buyer of commodities.

4. A method comprising:
setting a price level for a commodity;
loaning principal from a lender to a borrower;
selling the commodity at a market price; and
sharing a portion of any proceeds of the sale with the lender based the price level and the market price.

5. The method of claim 4, wherein sharing a portion of any proceeds comprises sharing the proceeds of the sale with the lender when the market price exceeds the price level.

6. The method of claim 4, wherein borrower agrees to pay to the lender interest on the principal amount, and wherein the lender agrees to reduce the interest to a rate below a prevailing amount in exchange for sharing the proceeds.

7. The method of claim 4, wherein the borrower comprises an agricultural producer.

8. The method of claim 4, wherein the borrower comprises a buyer of commodities.

9. The method of claim 4, wherein the price for the commodity comprises an end-of-season sale price.

10. The method of claim 4, wherein the price for the commodity comprises an average price.

11. A method comprising forming an agreement to loan a principal amount from a lender to a borrower at an interest rate in exchange for a promise by the lender to adjust at least one of the principal amount and the interest rate when a price for a commodity is below an agreed upon price level.

12. The method of claim 11, wherein the borrower comprises an agricultural producer.

13. The method of claim 11, wherein the lender comprises a buyer of commodities.

14. The method of claim 11, wherein the price for the commodity comprises an end-of-season sale price.

15. The method of claim 11, wherein the price for the commodity comprises an average price.

16. A method comprising:
setting a price level for a commodity;
loaning principal from a lender to a borrower in accordance with a loan having a an interest rate;
selling the commodity at a market price; and
adjusting at least one of the interest rate and the principal based the price level and the market price.

17. The method of claim 16, wherein adjusting one of the principal amount and the interest comprises reducing the principal amount.

18. The method of claim 16, wherein adjusting one of the principal amount and the interest comprises reducing the principal amount in proportion to the amount by which the market price at the time of the sale is below the critical low price.

19. The method of claim 16, further comprising setting a maximum adjustment for the interest rate.

20. The method of claim 16, further comprising setting a maximum adjustment for the principal.

21. A method comprising:
forming an agreement to loan a principal amount from a lender to a borrower at an interest rate;
forming the agreement to include a promise by the borrower to share with the lender proceeds from a future sale of a commodity when a first price for the commodity exceeds an agreed upon first price level; and
forming the agreement to include a promise by the lender to adjust at least one of the principal amount and the interest rate when a second price for the commodity is below an agreed upon second price level.

22. The method of claim 21, wherein the borrower comprises an agricultural producer.

23. The method of claim 21, wherein the lender comprises a buyer of commodities.

24. The method of claim 21, wherein at least one of the first price and the second price is an end-of-season market price.

25. A method comprising:
forming a first agreement to loan a principal amount from a lender to a borrower at an interest rate;
forming the first agreement to include a promise by the borrower to share with the lender proceeds from a future sale of a commodity when a first price for the commodity exceeds an agreed upon first price level;
forming the first agreement to include a promise by the lender to adjust at least one of the principal amount and the interest rate when a second price for the commodity is below an agreed upon second price level; and
forming a second agreement to transfer compensation from a guarantor to the lender in the event the lender adjusts at least one of the principal amount and the interest rate.

26. The method of claim 25, further comprising forming the second agreement to include a payment of interest on the principal by the guarantor.

27. The method of claim 25, further comprising forming the second agreement to include a payment of a fee by the guarantor.

28. The method of claim 25, further comprising forming the second agreement to include a promise by the lender to pay to the guarantor at least a portion of the shared proceeds from the future sale of the commodity when the first sale price for the commodity exceeds the agreed upon first price level.

29. The method of claim 25, wherein at least one of the first price and the second price is an end-of-season market price.

30. A method comprising:
forming a first agreement to loan a principal amount from a lender to a borrower at an interest rate;
forming the first agreement to include a promise by the borrower to share with the lender proceeds from a future sale of a commodity when a first price for the commodity exceeds an agreed upon first price level;
forming the first agreement to include a promise by the lender to adjust at least one of the principal amount and the interest rate when a second price for the commodity is below an agreed upon second price level; and
forming a second agreement to include a promise by the lender to pay to a guarantor at least a portion of the shared proceeds from the future sale of the commodity when the first price for the commodity exceeds the agreed upon first price level.

31. The method of claim 30, further comprising forming the second agreement to include a payment of interest on the principal by the guarantor.

32. The method of claim 30, further comprising forming the second agreement to include a payment of a fee by the guarantor.

33. The method of claim 30, further comprising forming the second agreement to transfer compensation from the guarantor to the lender in the event the lender adjusts at least one of the principal amount and the interest rate.

34. The method of claim 30, wherein at least one of the first price and the second price is an end-of-season market price.
